(19) United States
(12) Patent Application Publication
(10) Pub. No.: US 2003/0140537 A1
(43) Pub. Date: Jul. 31, 2003

(54) Mapping system

(76) Inventor: Charles Stefan Randak, Milngavie (GB)

Correspondence Address: Dykas Shaver & Nipper, The Hoff Building, Suite 405, 802 West Bannock, Boise, ID, 83702, US

(21) Appl. No.: 10/312,372

(22) PCT Filed: Jun. 22, 2001
(86) PCT No.: PCT/GB01/02788

(30) Foreign Application Priority Data
Jun. 24, 2000 (GB) 0015378.3

(51) Int. Cl. G09F 7/00; G09F 7/22

(52) U.S. Cl. 40/584; 40/617

(57) ABSTRACT

A mapping system is provided comprising a plurality of display panels (8) located at or on a ceiling of a building such as a supermarket. The panels (8) form a network of routes through the supermarket, with each panel illustrating the content of the supermarket aisle (4) adjacent the panel (8). The elevated nature of the panels (8) allows users to identify the content of aisles (4) distant from their current location, and users may thus identify a route leading to the selectred aisle as well as the contents of aisles along which the route passes. A number of alternative embodiments of the invention are described, together with methods of guiding individuals around environments using maps of the invention.

The present invention relates to a mapping system, particularly but not exclusively for use in guiding individuals around retail environments. The invention further relates to an apparatus for guiding an individual along a route; a method of guiding individuals around an environment; and to a building including a mapping system.

In many modern environments, such as supermarkets, airports, retail stores and the like, it is not always straightforward for individuals to navigate their way around the environment, or to identify the location of a desired service or item. For example, in supermarkets it is not unknown for customers to spend some time searching for the location of particular items, resulting in delays and frustration for the customer, and reducing the likelihood of that customer returning to the store. Similarly, airports can be particularly confusing environments around which to navigate, resulting in stress and delays not only to the individual concerned, but also possible delays and losses of revenue to airlines and frustration of other passengers.

While individuals can learn to navigate around such environments given time, this is only effective where the individual visits the environment a number of times, and does not help the first-time or infrequent visitor.

In many environments, therefore, signs are provided within the environment to direct individuals to desired locations. For example, supermarkets generally provide ceiling-mounted signs above particular aisles indicating the contents of that aisle (such as ‘wines and spirits’, ‘ready meals’ and the like). However, such signs are generally only visible to customers in the correct orientation and in the vicinity of the sign, and may be impossible to see from some areas of the store, even from an adjacent aisle. Furthermore, in relatively cluttered environments, for example a floor area divided by partition walls or the like, it may be possible for an individual to see a sign but not be able to plan a direct path toward the correct location; this can be more frustrating than not seeing a sign at all.

Further, while conventional signs may be used to direct individuals to areas around corners, by the use of appropriate direction arrows, the individual can only be so directed from those locations where the sign is visible. Added to this, the individual's eye is naturally drawn toward the sign rather than the destination indicated by the sign. If the direction of the indicator arrow is not clearly seen, or if the intended direction is not clearly discernable as a defined route or pathway, this does not assist the individual in finding their desired destination.

It is among the objects of embodiments of the present invention to obviate or alleviate at least some of these disadvantages of the prior art. This is achieved in certain embodiments of the invention in part by the provision of a signage or mapping system which indicates a substantially continuous route to be followed by the user.

According to a first aspect of the present invention, there is provided a mapping system for use in an environment, the system comprising a plurality of signs for defining a substantially continuous route within the environment, wherein each sign denotes a particular characteristic of the environment in the vicinity of said sign.

A ‘continuous’ route, as used herein, is intended to comprise both unbroken routes and those routes which include relatively short gaps or discontinuities. It will be apparent to the skilled person that the performance of the invention is little affected if the route contains short gaps, as compared with a completely unbroken route.

In use, therefore, the system of the present invention provides a continuous route which may be followed by a user, while the user's desired destination may be selected and identified according to the denoted characteristics displayed on one or more signs. For example, where the signs are displayed within a supermarket, each sign may indicate the contents of an aisle adjacent that particular sign. A user wishing to find, say, wines, may identify a remote sign displaying an image of a wine bottle and will also be able to identify one or more routes linking their present location with the location of the wine. Since the signs along the possible routes to the wine will indicate the contents of the aisle at each point along each route, the individual will also immediately be able to identify which areas of the supermarket they will pass through when following the chosen route. Thus, a shopping trip may be planned to involve less backtracking and time spent searching for items, thereby increasing customer satisfaction, and reducing customer stress and frustration.

References herein to a plurality of signs may refer to distinct individual signs, or a number of signs combined to provide in effect a single sign comprised of a number of units. In certain embodiments of the invention, one or more common extended structures may be provided on which are displayed a plurality of sign ‘regions’; that is, areas having distinct displays to thus form in effect a plurality of signs.

Preferably the environment is a retail environment, such as a supermarket, shopping mall or the like. However, the present invention may usefully be employed in other environments, such as airports and other transit or transport facilities, museums, industrial facilities, hospitals, and so forth.

The mapping system preferably comprises a plurality of possible routes. In certain embodiments, the mapping system comprises all possible routes within the environment; that is, signs are provided along all routes along which an individual may pass. This ensures that the individual will be able to find their desired destination regardless of where the start and end points of the route are.

The characteristics denoted by the signs will of course depend on the environment in which the mapping system is to be used. The characteristic may be, for example, representations of the contents of a shopping aisle, words, images, names or logos of retailers, suppliers, service providers, or airlines and the like. In other embodiments the characteristic might be, for example, images of a travel destination reached by boarding a train in the vicinity of the sign, or may merely allude to or imply a characteristic of the environment. The characteristic may imply a decision to be made by a user, for example, at a branch point along the route. Numerous alternatives will readily occur to the person of skill in the art.

The characteristics denoted by the signs may be fixed (for example, the signs may display printed images, still photographs or the like), or may alter over time (for example, electronically generated images, projections, animations, moving images, and the like). The latter alternative is of benefit where the environment may be reconfigured frequently; for example, the availability of different flights or destinations at airline check-in desks at an airport. In certain embodiments the signs may comprise a plurality of triangular section elements which may be rotated through 120° to display one of three available images.

The signs themselves may also be fixed or variable, in that the display of the signs may be fixed or alterable. Where the display is not fixed, the signs may comprise display screens or monitors, or the like; or may simply comprise replaceable printed inserts or the like.

The signs themselves may have a physical structure or presence, or may be for example remotely generated and projected to appear in space at a desired location.

Images may appear in the plane of the sign, or the signs may provide for the creation of real or virtual two- or three-dimensional images spaced from a screen.

Preferably the signs are adapted for location within the environment above eye-level of a user. Most conveniently the signs are for location on or suspended from a ceiling of an environment. Alternatively, the signs may be provided as part of a ceiling or the like. Such an arrangement improves the visibility of the signs, so allowing individuals to identify a complete route along the signs. Of course, it is not necessary that a complete route can be identified at once in all environments; for example, routes may be followed which turn corners or the like, so preventing the destination from being visible from the start. In such circumstances, however, a substantially complete portion of the route at least will nonetheless preferably be visible.

Preferably also the characteristics denoted by the signs are visible from beneath the level of the signs. For example, the signs may face generally downwards. This again improves visibility of the signs for a user at ground level, and from a distance away from the signs.

Preferably the signs are illuminated; this may be either external or internal illumination. Conveniently each sign comprises an illumination means located within the sign; for example, a light source may be provided behind a translucent sheet or screen bearing an image or the like.

The system may further comprise one or more layout displays reproducing the layout and depictions of the signs at a reduced scale. These may be provided as cards for individuals to carry to assist navigation; or may be located at various points within the environment for reference, typically at entry points to the environment. When provided within the environment, each layout display may include an indication thereon of the location of the layout display, to assist user orientation.

According to a second aspect of the present invention, there is provided a mapping system for use in an environment, the system comprising a plurality of signs for defining a substantially continuous route within the environment, wherein the signs are adapted for location above eye-level of a user, and are directed generally downwards.

The system of this aspect of the invention may thus be used to indicate a route to be followed in a form in which at least one of the route and the route ahead is capable of being seen from some distance. While the signs of the present invention may denote characteristics of the environment, this is not necessarily the case; for example, the signs may display simply a colour, or some characteristic of the destination of the route. This aspect of the invention is thus particularly of benefit where the whole of the route is not easily visible at once, such as where the route turns corners and the like. However, the route may be identified from a remote location, and once on or near the route, a user may anticipate the path the route follows. Thus, the user will have less difficulty in locating and following the route, and momentary lapses in concentration or attention are less likely to result in the route being lost, with attendant reductions in stress and frustration.

This aspect of the invention may be combined with the previous aspect of the invention, to provide a route with varying types of information thereon—for example, within an airport, a route may display symbols indicating ‘check-in’ along its length, to guide users to the general check-in area; thereafter routes may be provided leading to each airlines' check-in desk, the routes at this point displaying the logo or name of the particular airline at that desk.

According to a further aspect of the present invention, there is provided a mapping system for a store, comprising signs identifying items located in the areas of the signs, the signs being provided above such areas and facing downwards.

Preferably the signs are illuminated, most preferably from above with the signs provided on translucent material.

Preferably also the signs are provided above aisles along which customers may walk, and preferably the signs above the aisle are visible from other aisles.

Preferably also the signs are provided on one or more continuous pathways so as to simulate a route map through the store. The signs may be in the form of words, or more preferably illustrations of the items, or nature of items, provided in the area below.

The signs are preferably provided as part of the ceiling of the store, although they may alternatively be on separate structures, for example suspended from the roof or ceiling of the store.

It is useful for a diagram of the store's layout to be provided at one or more locations in the store, the diagram corresponding to the layout of the items in the store and reproducing the information and position of the signs. When a number of diagrams are provided, each one may advantageously include a ‘you are here’ indication to facilitate the customer's awareness of position.

According to a further aspect of the present invention, there is provided a route indicator comprising a plurality of signs defining a substantially continuous route within an environment, wherein each sign denotes a particular characteristic of the environment in the vicinity of said sign.

The indicator may further comprise means for mounting the signs in an elevated location within the environment.

According to a still further aspect of the present invention, there is provided a signage system for use in a retail environment, the system comprising a plurality of signs, each sign having means for displaying a particular characteristic of the environment in the vicinity of each sign, and means for mounting the signs in an elevated region of the environment to form a substantially continuous route within the environment.

According to a yet further aspect of the present invention, there is provided apparatus for guiding an individual along a route, the apparatus comprising a plurality of signs for location along said route to form a substantially continuous pathway, wherein each respective sign denotes a characteristic of the locality of the respective sign along the route.

Preferably the apparatus further comprises means for mounting the signs above eye level along the route.

The apparatus may comprise further signs for location along additional routes. The apparatus may comprise a network of routes.

According to a still further aspect of the present invention, there is provided a sign for use in a mapping system, the sign comprising means for mounting the sign to a location above eye level, and display means for displaying an image.

The mounting means may comprise brackets, screws, adhesive, or the like. Preferably the mounting means is arranged such that, in use, the image displayed by the display means is directed substantially downward of the display means.

Preferably the sign comprises a body on which the display means is provided. The mounting means may comprise cables, wires, rods or the like secured to the body for suspending the body from a ceiling or other part of a building. Preferably the body comprises illumination means for illuminating the display means. Preferably the illumination means comprises a lamp, light source, or the like. In preferred embodiments of the invention, the illumination means may be provided within the body, such that the display means is illuminated from behind. The body may further comprise reflection means for reflecting and directing illumination from the illumination means; for example, the body of the sign may be shaped to form a curved mirror surface within which is located a light source, such that light generated by the light source is reflected and projected forward onto the display means. The sign may still further comprise a light-diffusing harrier located adjacent the illumination means, for softening and diffusing the illumination. Conveniently the barrier comprises translucent plastic material, such as Perspex (RTM) or the like.

The display means may comprise a display screen, such as a cathode ray tube screen, an LED or LCD screen, or the like. The sign may then further comprise display driver means for programming the display screen and displaying a particular image or image sequence. The display driver means may comprise, for example, a suitably programmed general purpose computer device; alternatively, specific hardware may be used. The display driver means may be provided separately from the sign; for example, a plurality of signs may be centrally driven from a remote computer system. In selected embodiments the display screen may comprise a surface onto which an image may be projected; while the display driver comprises an image projector.

In a preferred embodiment, however, the display means comprises a medium printed with an image to be displayed. The medium may be fabric, plastics or the like, but is preferably paper. The display means preferably further comprises a cover or the like for retaining the medium on the sign; for example, a clear Perspex (RTM) cover may be mounted to the sign such that the medium is sandwiched between the cover and the sign. The medium is preferably removable or replaceable, to allow the image displayed on the sign to be replaced. Conveniently the cover is removable; alternatively, or in addition, the cover may provide an opening such as a slot, gap, or the like, into which a medium may be slid to allow replacement of the image.

According to a yet further aspect of the present invention, there is provided a method of guiding an individual around an environment, the method comprising the step of providing a plurality of signs in an elevated portion of the environment to form a substantially continuous route within the environment, wherein each of the signs displays a characteristic of the environment in the vicinity of that sign.

Preferably the method further comprises the step of providing the signs such that at least a substantially continuous section of the route is visible from eye level.

Preferably a beginning and an end of the route are visible from eye level.

A plurality of routes may be provided.

Preferably the environment is a retail environment.

According to a yet further aspect of the present invention, there is provided a method of indicating locations within an environment, the method comprising the step of providing a substantially continuous length of signs within the environment, wherein each sign denotes a characteristic of the environment in the vicinity of the respective sign.

According to a further aspect of the present invention, there is provided a method of generating revenue, the method comprising the steps of:

providing a plurality of signs in an elevated portion of an environment to form a substantially continuous route within the environment, wherein a plurality of the signs display a respective characteristic of the environment in the vicinity of those signs, and at least one of the signs also displays details of a sponsor; and

charging third parties for sponsor details to be displayed.

The step of charging third parties for selected details to be displayed may also be combined with a number of the above methods of the invention, allowing revenue to be generated from several of the methods of the invention.

The environment is conveniently a retail environment, although the invention may be utilised in any other public environment.

The third party charged may be the sponsor whose details are displayed, or a representative of the sponsor.

Some or all of the signs may display sponsor details. Similarly, some or all of the signs may display environmental characteristics.

The method may further comprise the step of periodically re-charging third parties for continued display of sponsor details.

According to a yet further aspect of the present invention, there is provided a building structure including a plurality of signs defining a substantially continuous route within the building, wherein each sign denotes a particular characteristic of the building in the vicinity of said sign.

The building structure may be an individual building, or may comprise a plurality of buildings in a complex or the like.

Preferably the signs are provided above eye level of a user within the building. Preferably also the signs are directed substantially downward, such that the signs are visible from eye level.

The building structure may be a retail building, such as a supermarket or the like.

According to a still further aspect of the present invention, there is provided a building structure including a plurality of signs forming a substantially continuous route within the environment, wherein the signs are located above eye level within the building, and are directed generally downwards.

These and other aspects of the present invention will now be described by way of example only and with reference to the accompanying drawings, in which:

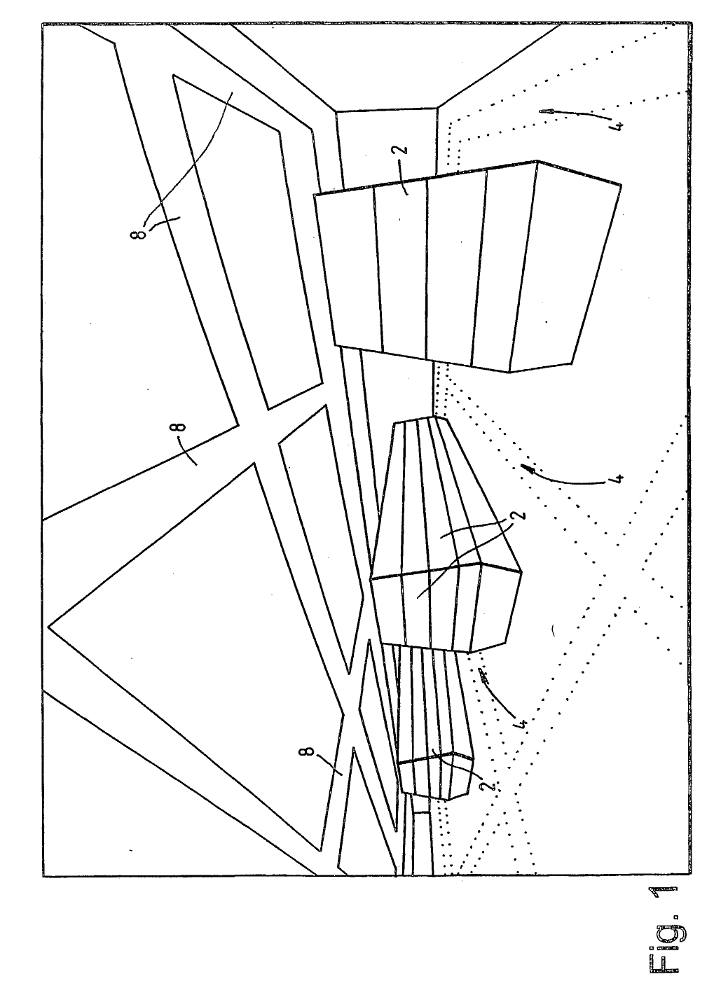

FIG. 1 is a general view of a store such as a supermarket including a mapping system of the invention;

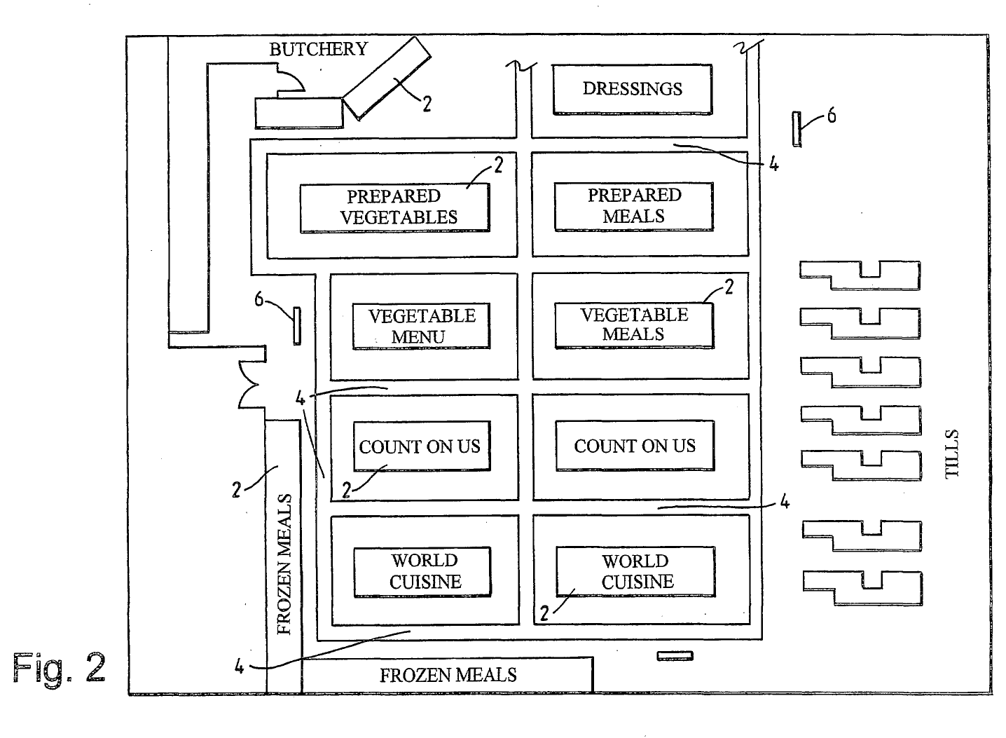

FIG. 2 is a diagram for use with the mapping system in the store illustrated in FIG. 1; and

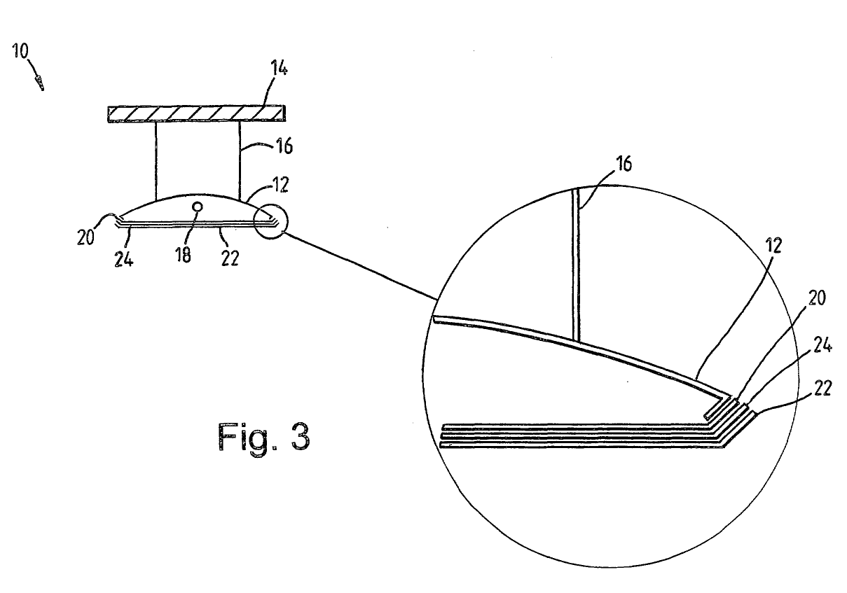

FIG. 3 is a sectional view of an embodiment of a sign which may be used with the mapping system of FIG. 1.

Referring to FIGS. 1 and 2, a store has a number of shelves 2 with aisles 4 between them for customers to walk along and collect items from the shelves 2. Diagrams 6 are provided near the entrance to the store and at locations throughout the store, each diagram 6 indicating the position of the various items on the shelves 2, and being presented in similar form to a street plan so that a customer can see where items of each type are located, and how they might be reached.

The diagrams 6 reproduce the layout of the aisles 4 and illustrate which items are on the shelves 2 adjacent the respective parts of the aisles 4.

Above the aisles 4, the ceiling of the store has set into it a back-illuminated network of translucent panels 8, these panels 8 having thereon illustrations of the items of the shelves 2 adjacent the section of aisle 4 below. Depending on the height of the ceiling, the height of the shelves 2, and the height of the shopper, the illustrations can be viewed and recognised from several aisles to the side, as well as from a distance along the same aisle.

The panels 8 are arranged, or back-lit, in such a manner as to be colour-coded so that selected background colours represent corresponding kinds of product of the shelves 2 adjacent the aisles 4 below. Thus for example, the panels 8 above the vegetable shelves have a background green colour, the panels 8 above the fruit shelves have a red colour, and so on. The customer can then readily identify the general area of the store in which particular products are likely to be found, even from a considerable distance.

The colours of the panels merge into one another to create a continuous and gradually changing coloured overhead pathway through the store, thus creating an attractive as well as informative environment for the customer.

The colour coding is reproduced on the diagrams 6 located at intervals throughout the store and at the entrance, thereby further facilitating the customer's awareness of the location of the items within the store.

FIG. 3 illustrates a section through a sign as may be used to create a mapping system as described. The sign 10 comprises an aluminium body frame 12 which is suspended from the ceiling 14 of a building by a pair of suspension cables 16. The frame 12 is concave, and is provided with a fluorescent light tube 18 located along the focus of the frame 12. The inner surface of the frame 12 is polished, thereby causing light produced by the tube 18 to be reflected downward from the sign 10.

Mounted over the frame 12, and in front of the fluorescent tube 18, is a translucent polymer diffuser screen 20, over which is mounted a clear polymer cover 22. Sandwiched between the screen 20 and cover 22 is a paper insert 24, printed with an image for display.

The insert 24 may be removed from the sign 10 by sliding the insert 24 from between the screen 20 and cover 22. Fresh inserts may then be added to the sign 10 in a similar manner, so allowing ready replacement of the image displayed should this be necessary.

Signs such as this may be simply retrofitted to existing buildings and constructions; it will of course be apparent that variations on the form of the sign may be used, particularly if the building (or the interior thereof) is to be constructed incorporating such a mapping system.

Although the invention has been described with reference to use in a supermarket, it will be apparent that the invention is not limited thereto. For example, the system may be used in an art gallery, with colour coding or other variation of the images borne by the signs used to indicate the period or school of paintings displayed adjacent the signs. Thus, using the invention, a gallery visitor may be able to identify from a distance the surrealist art section, identified by signs of a particular colour or bearing ‘surreal’ images, and plan a route thereto by following the layout of the signs mounted on the ceiling of the gallery.

A further variant may use signs coded to indicate the destination of the route; for example, a number of possible self-guided tours may be provided through an art collection, with users being able to identify the correct route to take by following, say, a red, green, or blue pathway of signs. The ability provided by the present invention to take in a section of the route at a glance allows users to determine how much of the route remains to be followed, and to identify possible short-cuts or alternative permutations if desired. Alternatively, or in addition, a particular pathway may have a particular theme, for example, Cubism, and the images displayed by signs along the pathway may reflect the work of the artists whose work is encompassed by the tour and the works on display in the vicinity of the signs.

In a further variation on the invention, the signs used may display, in addition to information regarding the locality of the signs, logos, corporate colour schemes or other symbols of sponsors of the signs or of the building or exhibition within which the signs are used. For example, each sign may indicate the logo of a sponsor of an art exhibition in addition to indicating the type of art displayed at that sign.

Signs used in embodiments of the present invention may also include further graphics or illustrations in addition to those included within the invention; for example, aesthetically-pleasing images unrelated to the environment may be included in addition to illustrations showing a characteristic of the environment. The signs may for example be used to enhance the environment in addition to displaying information relevant to the environment.

Although illustrated above with reference to a substantially open-plan supermarket, where most if not all of the route displayed by the signs may be seen at a glance, the invention is also applicable to areas where only a portion of the sign network may be seen at once; for example, hospitals or office buildings may have a number of corridors along which a mapping system may be disposed to allow individuals to follow a route to a desired destination. The provision of the signs in a visible elevated area provides a distinct advantage over conventional systems, since the signs may be visible from some distance along the corridor.

Further variations and modifications will be apparent to the skilled person, and may be made without departing from the scope of the invention.

1. A mapping system for use in an environment, the system comprising a plurality of signs for defining a substantially continuous route within the environment, wherein each sign denotes a particular characteristic of the environment in the vicinity of said sign.

2. The system of claim 1 wherein the environment is a retail environment.

3. The system of claim 1 or claim 2 comprising a plurality of possible routes.

4. The system of claim 3 comprising all possible routes within the environment.

5. The system of any preceding claim wherein the signs are adapted for location within the environment above eye-level of a user.

6. The system of claim 5 wherein the signs are for location on or suspended from a ceiling of an environment.

7. The system of claim 5 or claim 6 wherein the characteristics denoted by the signs are visible from beneath the level of the signs.

8. The system of claim 7 wherein the signs face generally downwards.

9. The system of any preceding claim wherein the signs are illuminated.

10. The system of claim 9 wherein each sign comprises an illumination means located within the sign.

11. The system of any preceding claim further comprising one or more layout displays reproducing the layout and depictions of the signs at a reduced scale.

12. A mapping system for use in an environment, the system comprising a plurality of signs for defining a substantially continuous route within the environment, wherein the signs are adapted for location above eye-level of a user, and are directed generally downwards.

13. A mapping system for a store, comprising signs identifying items located in the areas of the signs, the signs being provided above such areas and facing downwards.

14. The system of claim 13, wherein the signs are illuminated.

15. The system of claim 14 wherein the signs are illuminated from above with the signs provided on translucent material.

16. The system of any one of claims 13 to 15 wherein the signs are provided above aisles along which customers may walk.

17. The system of claim 16 wherein the signs above an aisle are visible from other aisles.

18. The system of any one of claims 13 to 17 wherein the signs are provided on one or more continuous pathways so as to simulate a route map through the store.

19. The system of any one of claims 13 to 18 wherein the signs are provided as part of the ceiling of the store.

20. A route indicator comprising a plurality of signs defining a substantially continuous route within an environment, wherein each sign denotes a particular characteristic of the environment in the vicinity of said sign.

21. The indicator of claim 20, further comprising means for mounting the signs in an elevated location within the environment.

22. A signage system for use in a retail environment, the system comprising a plurality of signs, each sign having means for displaying a particular characteristic of the environment in the vicinity of each sign, and means for mounting the signs in an elevated region of the environment to form a substantially continuous route within the environment.

23. Apparatus for guiding an individual along a route, the apparatus comprising a plurality of signs for location along said route to form a substantially continuous pathway, wherein each respective sign denotes a characteristic of the locality of the respective sign along the route.

24. The apparatus of claim 23 further comprising means for mounting the signs above eye level along the route.

25. The apparatus of claim 23 or 24 further comprising signs for location along additional routes.

26. A sign for use in a mapping system, the sign comprising means for mounting the sign to a location above eye level, and display means for displaying an image.

27. The sign of claim 26 wherein the mounting means is arranged such that, in use, the image displayed by the display means is directed substantially downward of the display means.

28. The sign of claim 26 or 27 wherein the sign comprises a body on which the display means is provided.

29. The sign of claim 28 wherein the body comprises illumination means for illuminating the display means.

30. The sign of claim 29 wherein the illumination means is provided within the body, such that the display means is illuminated from behind.

31. The sign of claim 30 wherein the body further comprises reflection means for reflecting and directing illumination from the illumination means.

32. The sign of claim 31 further comprising a light-diffusing barrier located adjacent the illumination means, for softening and diffusing the illumination.

33. The sign of any one of claims 26 to 32 wherein the display means comprises a display screen.

34. The sign of claim 33 wherein the sign further comprises display driver means for programming the display screen and displaying a particular image or image sequence.

35. The sign of any one of claims 26 to 32 wherein the display means comprises a medium printed with an image to be displayed.

36. The sign of claim 35 wherein the display means further comprises a cover or the like for retaining the medium on the sign.

37. The sign of claim 36 wherein the medium is removable or replaceable, to allow the image displayed on the sign to be replaced.

38. The sign of claim 37 wherein the cover provides an opening into which a medium may be slid to allow replacement of the image.

39. A method of guiding an individual around an environment, the method comprising the step of providing a plurality of signs in an elevated portion of the environment to form a substantially continuous route within the environment, wherein each of the signs displays a characteristic of the environment in the vicinity of that sign.

40. The method of claim 39 further comprising the step of providing the signs such that at least a substantially continuous section of the route is visible from eye level.

41. The method of claims 39 or 40 wherein a beginning and an end of the route are visible from eye level.

42. A method of indicating locations within an environment, the method comprising the step of providing a substantially continuous length of signs within the environment, wherein each sign denotes a characteristic of the environment in the vicinity of the respective sign.

43. A method of generating revenue, the method comprising the steps of:
providing a plurality of signs in an elevated portion of an environment to form a substantially continuous route within the environment, wherein a plurality of the signs display a respective characteristic of the environment in the vicinity of those signs, and at least one of the signs also displays details of a sponsor; and
charging third parties for sponsor details to be displayed.

44. The method of claim 43 wherein the environment is a retail environment.

45. The method of claims 43 or 44 wherein all of the signs display sponsor details.

46. The method of claims 43, 44 or 45 wherein all of the signs display environmental characteristics.

47. The method of any one of claims 43 to 46 further comprising the step of periodically re-charging third parties for continued display of sponsor details.

48. A building structure including a plurality of signs defining a substantially continuous route within the building, wherein each sign denotes a particular characteristic of the building in the vicinity of said sign.

49. A building structure including a plurality of signs forming a substantially continuous route within the environment, wherein the signs are located above eye level within the building, and are directed generally downwards.
